(19) United States
(12) Patent Application Publication
(10) Pub. No.: US 2013/0054415 A1
(43) Pub. Date: Feb. 28, 2013

(54) REFERRAL SYSTEM AND METHOD FOR SOURCING BUYER-REQUESTED ITEMS

(71) Applicant: Neelakantan Sundaresan, Mountain View, CA (US)

(72) Inventor: Neelakantan Sundaresan, Mountain View, CA (US)

(73) Assignee: eBay Inc., San Jose, CA (US)

(21) Appl. No.: 13/590,177

(22) Filed: Aug. 20, 2012

Related U.S. Application Data
(60) Provisional application No. 61/525,053, filed on Aug. 18, 2011.

(51) Int. Cl. G06Q 30/00

(52) U.S. Cl. 705/26.41

(57) ABSTRACT

A method and a system for a finder to send an acceptance that indicates that the finder has accepted a request to find an item requested by a requestor. The finder then sends an electronic notification to one or more other people about the request for the item, wherein the electronic notification includes a monetary incentive for the one or more other people in addition to the finder to assist in locating the item. The finder or the one person of the one or more other people sends location information. The location information includes a seller's contact information or a listing within an online marketplace describing the item. The finder and the one person of the one or more other people receive compensation based on assisting in locating the requested item.

### RELATED APPLICATIONS

This application is related to and hereby claims the priority benefit of U.S. Provisional Patent Application No. 61/525,053 filed on Aug. 18, 2011, and entitled “REFERRAL SYSTEM AND METHOD FOR SOURCING BUYER-REQUESTED ITEMS”, which application is incorporated herein by reference in its entirety.

### TECHNICAL FIELD

Example embodiments of the present disclosure relate generally to electronic commerce, and more specifically, in an example embodiment, to a referral system and method for sourcing hard-to-find items.

### BACKGROUND

Certain electronic commerce providers enable users to buy and sell goods and services in online marketplaces. Generally, users create listings to sell goods and services by entering information concerning the good or service offered for sale. In certain cases, items may be difficult to find or scarce. In these cases, potential buyers may become frustrated such that the experience of the buyer using the electronic commerce provider is diminished and damaged.

### BRIEF DESCRIPTION OF THE DRAWINGS

Example embodiments of the present disclosure are illustrated by way of example, and not by way of limitation, in the figures of the accompanying drawings.

FIG. 1 is a block diagram illustrating a network architecture of a system, according to some embodiments, having a client-server architecture configured for exchanging data over a network.

FIG. 2 is a block diagram illustrating various components of a network-based publisher, according to some embodiments.

FIG. 3A is a block diagram illustrating various tables that may be stored, according to some embodiments, within a database.

FIG. 3B is a table illustrating one of the tables from FIG. 3A, according to some embodiments, and is stored within the database.

FIG. 3C is a hierarchical structure illustrating the use of a social network to find an item according to some embodiments.

FIG. 4 is a screen shot illustrating a browsing function useful in an embodiment.

FIG. 5 is a screen shot illustrating a request function useful in an embodiment.

FIG. 6 is a screen shot illustrating a participant's view of a page useful in an embodiment.

FIG. 7 is a screen shot illustrating another example of a participant's view of a page in an embodiment.

FIG. 8 is a screen shot illustrating a communication useful in an embodiment.

FIG. 9 is a screen shot illustrating a notification function useful in an embodiment.

FIGS. 10A-10B are a representation of a flowchart depicting operations of an embodiment.

FIG. 11 shows a diagrammatic representation of a machine in the example form of a computer system within which a set of instructions may be executed to cause the machine to perform any one or more of the methodologies discussed herein.

### DETAILED DESCRIPTION

Methods and systems to source buyer-requested items, such as scarce or hard-to-find items, using a referral method and system are disclosed. In the following description, for purposes of explanation, numerous specific details are set forth in order to provide a thorough understanding of the present disclosure. It may be evident, however, to one skilled in the art that the subject matter of the present disclosure may be practiced without these specific details.

Often times a buyer wants an item, but cannot find the item listed for sale. This may because the item is rare and/or a hard to find item. The buyer (requestor) generates a request for an item with details about the item, price, pictures, and/or time they want the item by. The system then determines keywords based on the description of the item and searches a database to find users who may have the item. The database stores information relating to users' linked social media accounts, social connections, and/or transaction history of items bought, sold, and/or found. Based on that search, the system determines one or more users who may have the item or know where the item is located. The system then sends a message to the one or more users with details about the item requested to be found.

A user (finder) then accepts to find the item. If the finder has the item, then the finder notifies the requestor. However, if the finder does not have the item, then the finder sends a message to one or more other friends, through email or messaging system within social media, and/or a post in social media. The message indicates that compensation will be paid for assisting in locating the item. The compensation may be a percentage of a finder's fee or a based number of levels of a social media structure needed to find the item. When the item is found, the finder notifies the requestor and completes the sale. The finder and any friends that assisted in locating the item then receive compensation based on their assistance in locating the item.

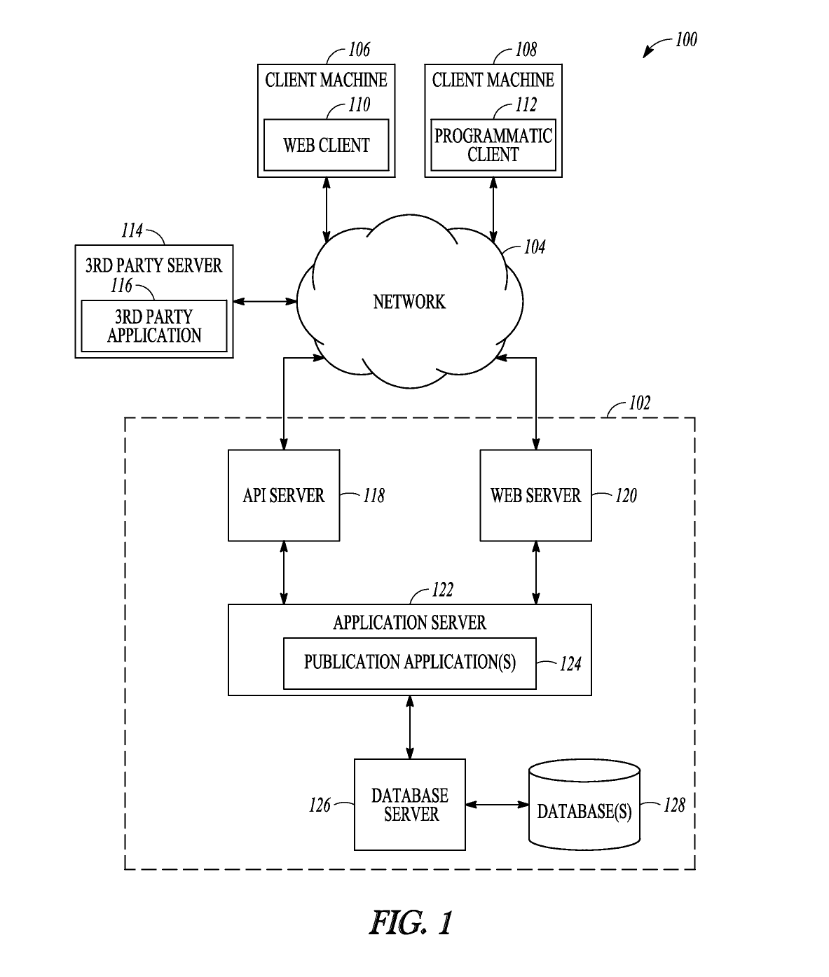

FIG. 1 is a network diagram depicting a network system 100, according to one embodiment, having a client-server architecture configured for exchanging data over a network 104. For example, the network system 100 may be a publication/publisher system 102 where clients may communicate and exchange data within the network system 100. The data may pertain to various functions (e.g., selling and purchasing of items) and aspects (e.g., data describing items listed on the publication/publisher system) associated with the network system 100 and its users. Although illustrated herein as a client-server architecture as an example, other example embodiments may include other network architectures, such as a peer-to-peer or distributed network environment.

A data exchange platform, in an example form of a network-based publisher 102, may provide server-side functionality, via a network 104 (e.g., the Internet) to one or more clients 106, 108. The one or more clients 106, 108 may include users that utilize the network system 100 and more specifically, the network-based publisher 102, to exchange data over the network 114. These transactions may include transmitting, receiving (communicating) and processing data to, from, and regarding content and users of the network system 100. The data may include, but are not limited to, content and user data such as feedback data; user reputation values; user profiles; user attributes; product and service reviews; product, service, manufacture, and vendor recommendations and identifiers; product and service listings associated with buyers and sellers; auction bids; and transaction data, among other things.

In various embodiments, the data exchanges within the network system 100 may be dependent upon user-selected functions available through one or more client or user interfaces (UIs). The UIs may be associated with a client machine, such as a client machine 106 using a web client 110. The web client 110 may be in communication with the network-based publisher 102 via a web server 120. The UIs may also be associated with a client machine 108 using a programmatic client 112, such as a client application, or a third party server 114 hosting a third party application 116. It can be appreciated in various embodiments the client machine 106, 108, or third party application 114 may be associated with a buyer, a seller, a third party electronic commerce platform, a payment service provider, or a shipping service provider, each in communication with the network-based publisher 102 and optionally each other. The buyers and sellers may be any one of individuals, merchants, or service providers, among other things.

Turning specifically to the network-based publisher 102, an application program interface (API) server 118 and a web server 120 are coupled to, and provide programmatic and web interfaces respectively to, one or more application servers 122. The application servers 122 host one or more publication application(s) 124. The application servers 122 are, in turn, shown to be coupled to one or more database server(s) 126 that facilitate access to one or more database(s) 128.

In one embodiment, the web server 120 and the API server 118 communicate and receive data pertaining to listings, transactions, and feedback, among other things, via various user input tools. For example, the web server 120 may send and receive data to and from a toolbar or webpage on a browser application (e.g., web client 110) operating on a client machine (e.g., client machine 106). The API server 118 may send and receive data to and from an application (e.g., client application 112 or third party application 116) running on another client machine (e.g., client machine 108 or third party server 114).

The publication application(s) 124 may provide a number of publisher functions and services (e.g., search, listing, payment, etc.) to users that access the network-based publisher 102. For example, the publication application(s) 124 may provide a number of services and functions to users for listing goods and/or services for sale, searching for goods and services, facilitating transactions, and reviewing and providing feedback about transactions and associated users. Additionally, the publication application(s) 124 may track and store data and metadata relating to listings, transactions, and user interactions with the network-based publisher 102.

FIG. 1 also illustrates a third party application 116 that may execute on a third party server 114 and may have programmatic access to the network-based publisher 102 via the programmatic interface provided by the API server 118. For example, the third party application 116 may use information retrieved from the network-based publisher 102 to support one or more features or functions on a website hosted by the third party. The third party website may, for example, provide one or more listing, feedback, publisher or payment functions that are supported by the relevant applications of the network-based publisher 102.

While the example network architecture 100 of FIG. 1 employs a client-server architecture, a skilled artisan will recognize that the present disclosure is not limited to such an architecture. The example network architecture 100 can equally well find application in, for example, a distributed or peer-to-peer architecture system.

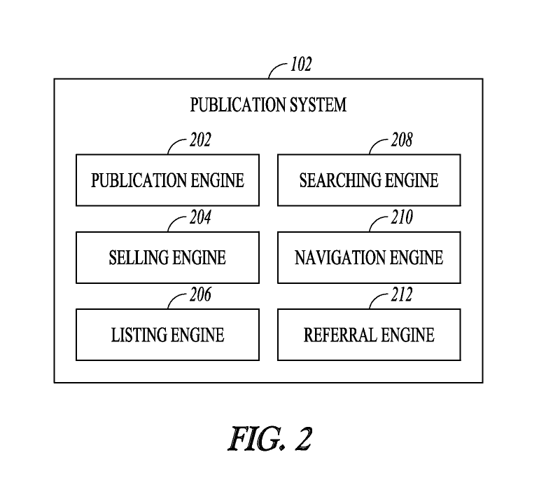

Referring now to FIG. 2, an example block diagram illustrating multiple components that, in one example embodiment, are provided within the network-based publisher 102 of the networked system 100 is shown. The publication system 102 may be hosted on dedicated or shared server machines (not shown) that are communicatively coupled to enable communications between the server machines. The multiple components, themselves, are communicatively coupled (e.g., via appropriate interfaces), either directly or indirectly, to each other and to various data sources, to allow information to be passed between the components or to allow the components to share and access common data. Furthermore, the components may access the one or more database(s) 128 via the one or more database servers 126, both shown in FIG. 1.

In one embodiment, the publication system 102 comprises a network-based marketplace and provides a number of publishing, listing, and price-setting mechanisms whereby a seller (e.g., business or consumer) may list (or publish information concerning) goods or services for sale, a buyer can search for, express interest in, or indicate a desire to purchase such goods or services, and a price can be set for a transaction pertaining to the goods or services. In some embodiments, a buyer may also post listings containing items the buyer is looking to purchase. Sellers may view listings posted by buyers and may provide the item to the buyer if possible, by, in some embodiments, providing the item to the buyer directly or by redirecting the buyer to a listing of the requested item that has been posted by the seller.

To this end, the publication system 102 may comprise at least one publication engine 202 and one or more selling engines 204. The publication engine 202 may publish information, such as item listings or product description pages, on the publication system 102. In some embodiments, the selling engines 204 may comprise one or more fixed-price engines that support fixed-price listing and price setting mechanisms and one or more auction engines that support auction-format listing and price setting mechanisms (e.g., English, Dutch, Chinese, Double, Reverse auctions, etc.). The various auction engines may also provide a number of features in support of these auction-format listings, such as a reserve price feature whereby a seller may specify a reserve price in connection with a listing and a proxy-bidding feature whereby a bidder may invoke automated proxy bidding.

A listing engine 206 allows sellers to conveniently author listings of items or authors to author publications. In one embodiment, the listings pertain to goods or services that a user (e.g., a seller) wishes to transact via the publication system 102. Each good or service is associated with a particular category. The listing engine 206 may receive listing data such as title, description, and aspect name/value pairs. Furthermore, each listing for a good or service may be assigned an item identifier. In other embodiments, a user may create a listing that is an advertisement or other form of information publication. The listing information may then be stored to one or more storage devices coupled to the publication system 102 (e.g., databases 128). Listings also may comprise product description pages that display a product and information (e.g., product title, specifications, reviews) associated with the product. In some embodiments, the product description page may include an aggregation of item listings that correspond to the product described on the product description page.

The listing engine 206 also may allow buyers to conveniently author listings or requests for items desired to be purchased. In some embodiments, the listings may pertain to goods or services that a user (e.g., a buyer) wishes to transact via the publication system 102. Each good or service is associated with a particular category. The listing engine 206 may receive as much or as little listing data, such as title, description, and aspect name/value pairs, that the buyer is aware of about the requested item. In some embodiments, the listing engine 206 may parse the buyer's submitted item information and may complete incomplete portions of the listing. For example, if the buyer provides a brief description of a requested item, the listing engine 206 may parse the description, extract key terms and use those terms to make a determination of the identity of the item. Using the determined item identity, the listing engine 206 may retrieve additional item details for inclusion in the buyer item request. In some embodiments, the listing engine 206 may assign an item identifier to each listing for a good or service.

Searching the network-based publication system 102 is facilitated by a searching engine 208. For example, the searching engine 208 enables keyword queries of listings published via the publication system 102. In example embodiments, the searching engine 208 receives the keyword queries from a device of a user and conducts a review of the storage device storing the listing information. The review will enable compilation of a result set of listings that may be sorted and returned to the client device (e.g., client device 106) of the user. The searching engine 308 may record the query (e.g., keywords) and any subsequent user actions and behaviors (e.g., navigations).

In a further example, a navigation engine 210 allows users to navigate through various categories, catalogs, or inventory data structures according to which listings may be classified within the publication system 102. For example, the navigation engine 210 allows a user to successively navigate down a category tree comprising a hierarchy of categories (e.g., the category tree structure 100) until a particular set of listing is reached. Various other navigation applications within the navigation engine 210 may be provided to supplement the searching and browsing applications. The navigation engine 210 may record the various user actions (e.g., clicks) performed by the user in order to navigate down the category tree.

In some embodiments in which a buyer posts a listing seeking to find an item, a referral engine 212 may incentivize sellers to provide the item to the buyer. For example, a buyer may post a listing seeking an item. In some embodiments, the item may be a scarce or hard-to-find item. The referral engine 212 may promote a network-based publisher 102 policy of awarding a commission, finder fee, or referral fee to a seller who supplies the buyer with the item. In some embodiments, the commission may be awarded on a listing-by-listing basis rather than for every buyer-generated listing.

In some embodiments, a seller may not be able to provide a requested item to the buyer, especially in scenarios where the requested item is rare, scarce, or hard-to-find. The referral engine 212 may attempt to remedy these and other situations by offering a tiered commission or referral fee scheme to incentivize sellers to provide buyer-requested items to buyers. In some embodiments, a seller who is able to directly provide a requested item to a buyer may receive a first commission rate. This seller may be referred to as a zero-degree seller. If the zero-degree seller is unable to directly provide the requested item to the buyer, the zero-degree seller may refer the buyer-generated item request to other sellers (i.e., first-degree sellers) in the zero-degree seller's network. If one of the first-degree sellers is able to provide the buyer-requested item to the buyer, the referral engine 212 may award a commission to the first-degree seller and a commission or referral fee to the zero-degree seller for referring the buyer-generated item request to the supplying first-degree seller. Similarly, if the first-degree sellers are unable to provide the buyer-requested item, the first-degree sellers may further refer the buyer-generated item request to sellers in their network (i.e., second-degree sellers with respect to the original zero-degree seller). The referral scheme may continue theoretically for n degrees of sellers, with each referring tier of sellers being awarded a commission if a seller in the tier of sellers eventually is able to supply the requested item to the buyer.

In some embodiments, the commission to be paid to a seller who supplies a requested item to a buyer is sub-dividable. For example, in some embodiments, a greater percentage of the commission may be awarded to the seller who actually provides the requested item to the buyer. A smaller percentage of the commission may be awarded to a referring seller. In the event of multiple degrees or tiers of referring sellers, a larger commission may be awarded to a seller who directly refers the buyer-generated item request to the supplying seller than to a seller who is more than one degree removed from the supplying seller. In other embodiments, the original referring seller may receive a larger commission than each subsequent referring seller, although in some embodiments, the supplying seller may still receive the largest share of the commission.

In some embodiments, the referral engine 212 may track referrals made by sellers and use the tracked data to establish a network or social graph for each seller. In some embodiments, one or more sellers may access and use a third party content provider or social network to retrieve contact information of potential sellers to whom the one or more sellers may send referrals. In these instances, the referral engine 212 may interface with the third party providers or social networks to retrieve the social network for a particular seller. The referral engine 212 further may record interactions with third party providers or social networks to maintain a copy of the seller's social network or set of contacts.

In some embodiments, one or more of the engines described with reference to FIG. 2 may be implemented or executed by one or more processors. Additionally, in some embodiments, one or more of the engines described with reference to FIG. 2 may comprise one or more modules to carry out specific operations or tasks for the engine. For example, although not shown in FIG. 2, the referral engine 212 may include an interface module to interface with third party content providers or social networks. The interface component may leverage an Application Programming Interface (API) exposed by the third party content provider or social network to generate an API call to retrieve seller contacts or a seller network. The referral engine 212 also may include a commission module to award varying percentages or amounts of commission upon the successful sale and provisioning of a requested item to a requesting buyer. The referral engine 212 also may include a referral module that generates referral notifications or offers on behalf of one or more sellers.

Although the various components of the publication system 102 have been discussed in terms of a variety of engines and modules, one of skill in the art will recognize that many of the items can be combined or organized in other ways. Furthermore, not all components of the publication system 102 have been included in FIG. 2. In general, components, protocols, structures, and techniques not directly related to functions of example embodiments (e.g., dispute resolution engine, loyalty promotion engine, reputation engines, listing management engines, account engine) have not been shown or discussed in detail. The description given herein simply provides a variety of example embodiments to aid the reader in an understanding of the systems and methods used herein.

In some embodiments, referral methods for sourcing buyer-requested items are performed based on the disclosure herein. For example, a method may include one or more of receiving a buyer-generated item request, in the form of an item listing, for example, receiving an indication that a seller has viewed the buyer-generated item request, receiving an indication that the seller has referred the buyer-generated item request to another seller, receiving an indication that the referred seller is able to supply the requested item, determining an amount of commission to award to the referring and referred sellers, and awarding the commission amounts to the referring and referred sellers. In some example methods, the referrals are tracked and used to build a network of contacts or a social graph for each seller. In some example methods, referrals from one seller to another are generated in response to the receipt of an indication from a seller that he or she desires to refer the buyer-generated item request to the other seller. In some example methods, the total commission and the varying amounts of commission offered to referring and referred sellers may be defined by the network-based publisher or by the buyer.

### Data Structures

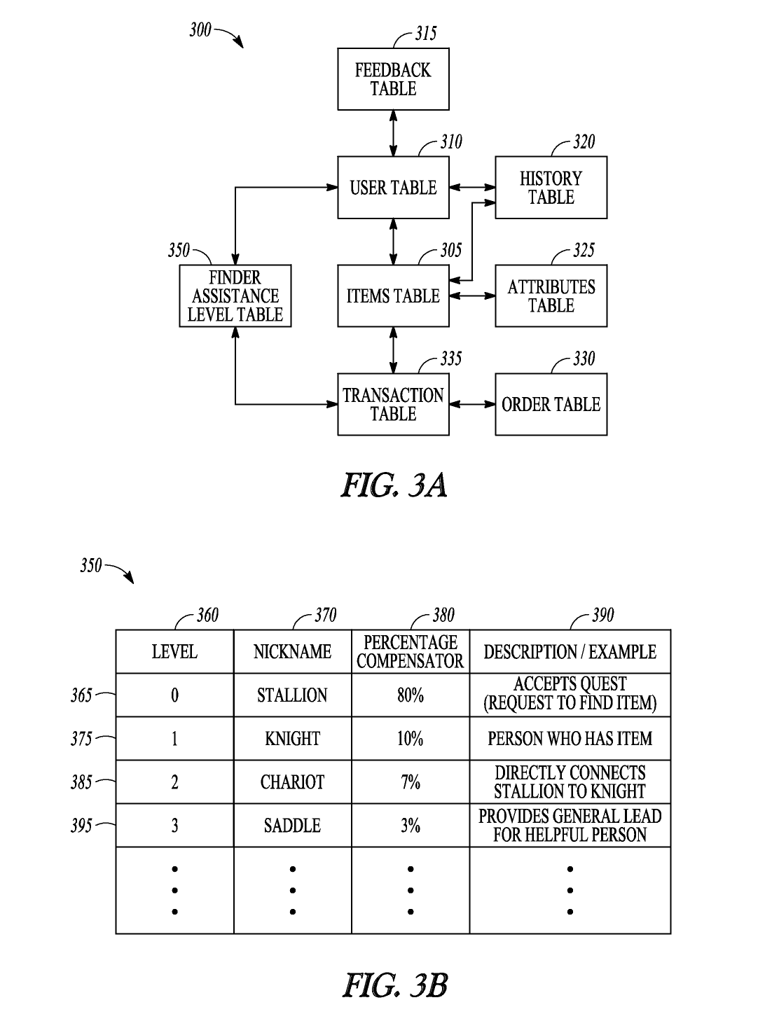

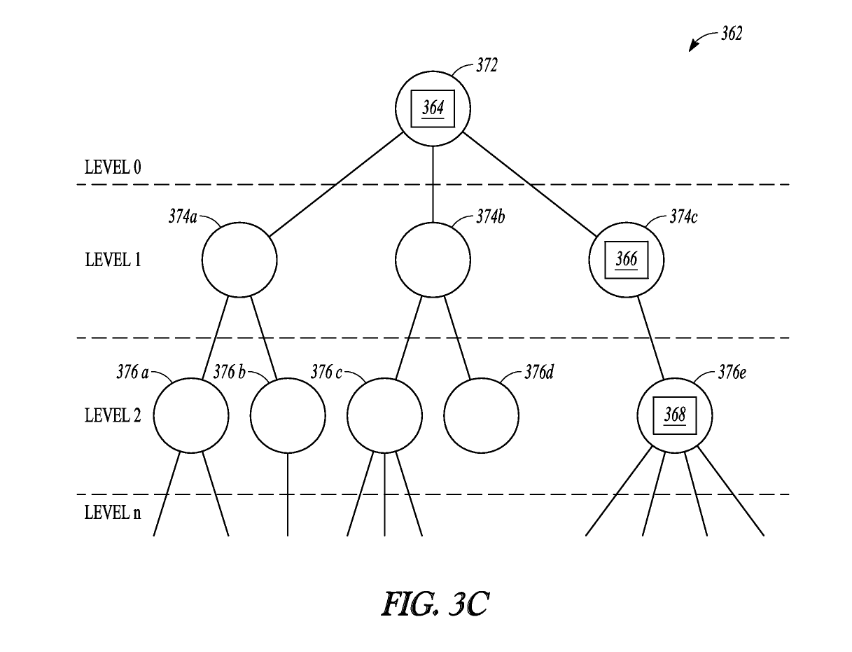

FIG. 3A is a high-level entity-relationship diagram, illustrating various tables 300 that may be maintained within databases 126, and that are utilized by and support the applications 120 and 122. A user table 310 contains a record for each registered user of the networked system 102, and may include identifier, address and financial instrument information pertaining to each such registered user. A user may operate as a seller, a buyer, a requestor, a searcher, or more than one function, within the networked system 102. In one example embodiment, a buyer may be a user that has accumulated value (e.g., commercial or proprietary currency), and is accordingly able to exchange the accumulated value for items that are offered for sale by the networked system 102.

The tables 300 also include an items table 305 in which are maintained item records for goods and services that are available to be, or have been, transacted via the networked system 102. Each item record within the items table 305 may furthermore be linked to one or more user records within the user table 310, so as to associate a seller and one or more actual or potential buyers with each item record.

A transaction table 335 contains a record for each transaction (e.g., a purchase or sale transaction) pertaining to items for which records exist within the items table 305.

An order table 330 is populated with order records, each order record being associated with an order. Each order, in turn, may be with respect to one or more transactions for which records exist within the transaction table 335.

A feedback table 315 may be utilized by one or more reputation applications (not shown), in one example embodiment, to construct and maintain reputation information concerning users. A history table 320 maintains a history of transactions to which a user has been a party. One or more attributes tables 325 record attribute information pertaining to items for which records exist within the items table 305. Considering only a single example of such an attribute, the attributes tables 325 may indicate a currency attribute associated with a particular item, the currency attribute identifying the currency of a price for the relevant item as specified in by a seller. A finder assistance level table 350 may be utilized by a referral engine 212, in one example embodiment, to construct and maintain compensation percentages when multiple people assist in locating a requested item.

FIG. 3B provides an example version of a finder assistance level table 350 that is shown in FIG. 3A and is maintained within databases 126. The finder assistance table 350 may include a level designation 360, a nickname designation 370, an assigned percentage of compensation 380, and/or description and/or example 390 of the assistance provided for assigning level of assistance to the participants who participated in locating an item. The percentage of compensation is based on sharing a percentage of a finder's fee for the item. For example, an item that costs $100 may include a finder's fee of $10. Row 365 shows how a person who signs up to find an item receives 80% of the finder fee and in this example $8. The person who signs up to find an item is nicknamed a stallion and receives compensation as a level zero. Row 375 shows that a person who provides an item is a level one and nicknamed a knight. The knight receives 10% of the finder fee plus the sale price, which in this example is $91. Row 385 shows compensation for a level 2 user who may provide assistance in locating an item. The level 2 is nicknamed a chariot and they provide for example a direct link between the stallion (level 0) and the knight (level 1). The compensation for the chariot in this example would $0.70. Row 395 shows another level of assistance that may be provided by a user in locating an item. Row 395 is a level 3 type of assistance, and for example may be a general lead of a helpful type of person. The level 3 user is nicknamed a saddle and may receive 30% of the finder fee or in this example $0.30. Additional levels of users may also be included with different percentages of the finder's fee applied. Additionally, the percentage may change based on the number users used to find the item, the percentages may be set by the level zero user when they accept a request to find an item, and/or they may change based on being a percentage of a sale price or percentage of a finder's fee.

Alternatively, the table may provide different calculations for paying each participant that assists in a search for an item. FIG. 3C illustrates a hierarchy structure 362 of social network messages sent between different users. For example, if user 372 signs up to find item 364 and item 364 is found by user 372, then user 372 receives the entire commission for the sale. In other words, item 364 was found through zero-levels of a social media structure. Alternatively, if user 362 signs up to find item 366 and does not have it, user 372 sends messages to users 374a-374c. The messages sent include an incentive to assist in finding the item or providing the item. In this case user 374c provides item 366, thus user 374c receives most of the sale price and user 372 receives a small portion of the sale price for referring the requestor to user 374c. In this example, item 366 is provided through a first-level of the social media structure. In another example, if user 372 signs up to find item 368 and does not have item 368, then user 372 sends out messages to users 374a-374c. If users 374a-374c do not have item 368, then anyone of them may send out messages to users 376a-376e. If user 376e has item 368, then user 376e receives the largest percentage of compensation for item 368, and user 374c receives a smaller percentage and 372 receives the smallest percentage. In other words item 368 was found through a second-level of a social media structure. Alternatively, the percentage supplied to user 372 may be higher than to user 374c because user 372 signed-up to find the item.

Additionally, any number of levels of social media may be used to find the item with the participant providing the item receiving the largest percentage of the sale price and each level removed from the user that provides the item receiving less than the level before that user. If there were n levels, then the user on the n-level who supplies the item receives the most compensation, the user on n-1 receives the next highest amount, the user on the n-2 level receives a lower amount then the user on the n-1 level, the user on the n-3 level receives a lower amount then the user on n-2 level, and so back to the user on the zero level. Alternatively, if there were n levels, then the user on the n-level who supplies the item receives the most compensation, the user on zero-level receives the next highest amount because they accepted the request to find the item, the user on the n-1 level receives a lower amount then the user zero-level, the user on the n-2 level receives a lower amount then the user on n-1 level, and so on. The users do not all need to be part of the system to receive payment for their services, but they do need an email or other social media account to provide payment too.

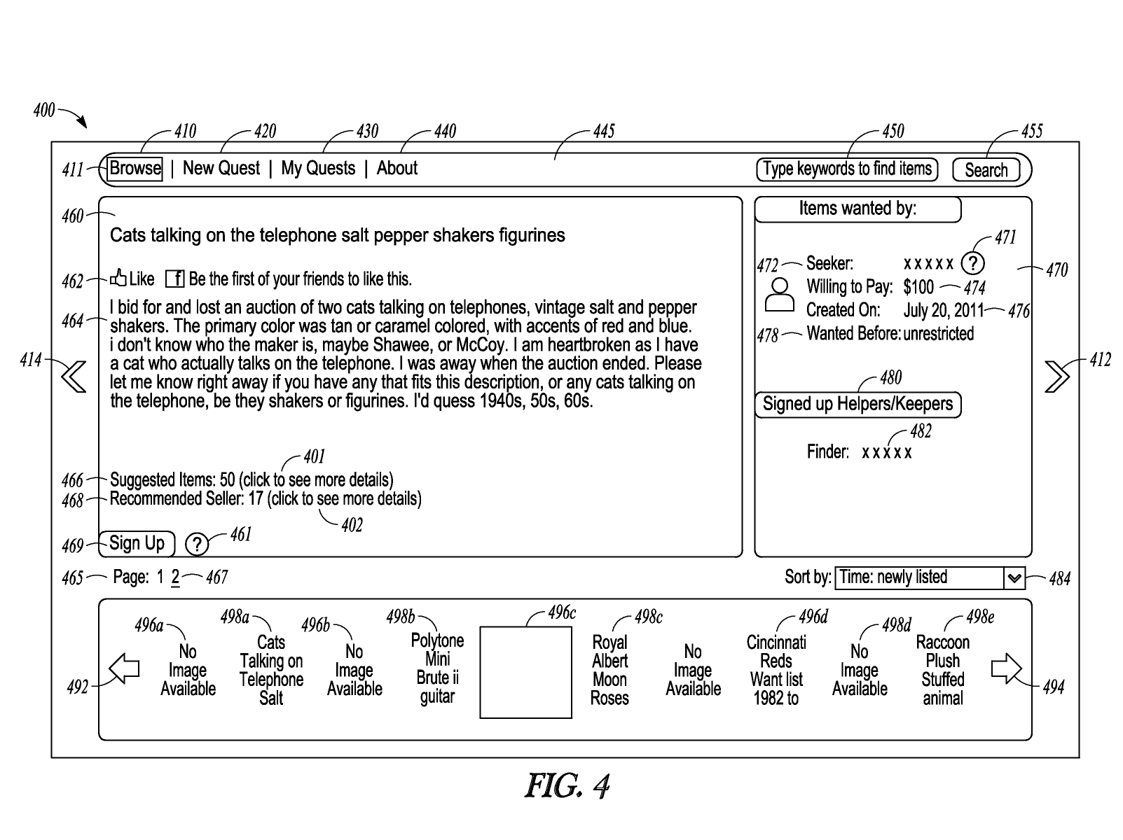

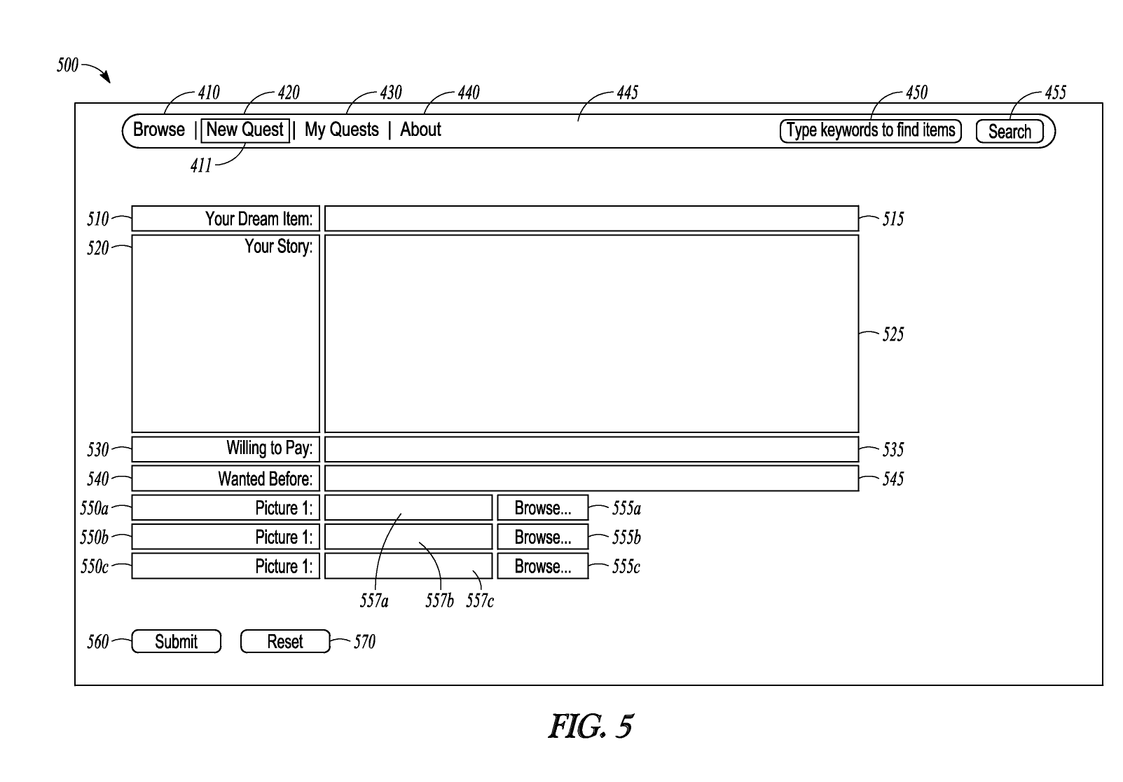

FIG. 4 is a screen shot illustrating a browsing function 400 for a user to find different items to find. The browsing function 400 includes a tool bar 445 with a box 411 around browse 410 indicating that the browse function 400 is displayed. Alternatively of box 411, the word may be highlighted or a different color. The tool bar 445 may also include links to other functions including a new quest function (requestor function) 420, my quests (listing of items signed up to find) 430, and/or an about function 440. The about function 440 provides information and/or help to users about the request and find system. The tool bar 445 may also include a box 450 for entering one or more keywords to allow a user to perform a search function 455.

Box 460 shows a detailed description 464 of an item to be found, and in this example the item is “cats talking on telephone salt and pepper shaker figurines.” The detailed description box 460 may also include a link 462, which is a link to social media, such as a “like” button on Facebook®. The detailed description box 462 may also include a number of suggested items 464 and suggested sellers 466. The suggested items may be determined by the referral engine 212 performing a keyword or search term search of users, social media data collected from users' linked social media accounts, social connections from users' linked social media accounts, transaction data, and/or other history information to find sellers and/or similar products. Alternatively, the suggested items 464 and/or suggested sellers 466 may be inputted by the requestor when generating the request for the item. Also, detailed description box may include a link 401, 402 to view the suggested items 464 and the suggested sellers 466, respectively. Sign-up box 469 allows a user to sign up to search for the requested item listed in the detailed description box 460. Help button 461 may provide assistance to a user about searching for an item and compensation system that may be used.

When a user signs up to find an item they are then listed in signed up helpers/keepers box 480. Signed up helpers/keepers box 480 may be an empty list if no one has signed up to find an item or may include one listing 482 when a single user has signed up to find the item or may include many listings when multiple users have signed up to find the item. The listing may also include the names of users assisting the initial user who signed up to find the item. The additional helping users may be entered directly by the user accepting the request to find the item, entered based on messages sent from within the system to other users, and/or based on linked social media accounts.

Requestor information block 470 gives information about the requested item including requestor (seeker) 472, a price the requestor is willing to pay 474, when the request was created 476, and when the item is wanted before 478. The wanted before info 478 may include a set date or may be unrestricted when no specific date is set. Also, help link 471 includes a link for helpful resources relating requesting and/or signing up to find an item.

Result display box 490 displays items to be found with titles 498a-498e and if available pictures 496a-496d. Arrows 492, 494 assist the user in scrolling through items wanted. Arrows 492, 494 may provide the next item wanted to view or a whole new box or page of items wanted. Additionally, the display function may also include arrows 412, 414 for providing a way to scroll through detailed description box 460 of multiple requested items quickly. The number of pages 465 found by a keyword search are displayed with a link 467 to other pages. The results from the keyword search maybe sorted by different requirements 484. For example, the results may be displayed based on time with newly listed first, based on percentage match of keyword search, based on similar items found by finder previously, or other similar methods. Alternatively, instead of a keyword search the referral engine 212 may organize the wanted items in categories and then the items wanted can be viewed based on category.

FIG. 5 is a screen shot illustrating a request function 500 that a requestor (seeker) may use to request an item found. A requestor enters a title 510 of the item they want in box 515, and a description of the item 520 in box 525. The description 520 may be a story on where they had the item previously or who they saw it selling, but the detailed description 520 should include as many details that the requestor knows about the item. This may include a previous name of the user and/or username of the person selling the item, details about why the person wants the item, place they came across the item in real life or online, etc. Willing to pay box 530 allows the requestor to enter a price they are willing to pay in box 535. This price does not need to be fixed and the finder may need to negotiate prior to completing the sale. A wanted before box 540 allows a requestor a time period to find the item by or they may put in “unrestricted” if there is no deadline in box 545. If the requestor has a picture of the item, then the requestor may upload the one or more pictures in picture boxes 550a-550c. The requestor selects browse buttons 555a-555c to find the picture or pictures that they want to upload and the addresses of the picture or pictures are loaded into boxes 557a-557c. To submit the request, the requestor clicks the submit button 560. There also maybe a preview button (not shown) to allow a requestor to preview the listing for the requested listing prior to submitting with the referral engine 212. Reset button 570 clears form 500.

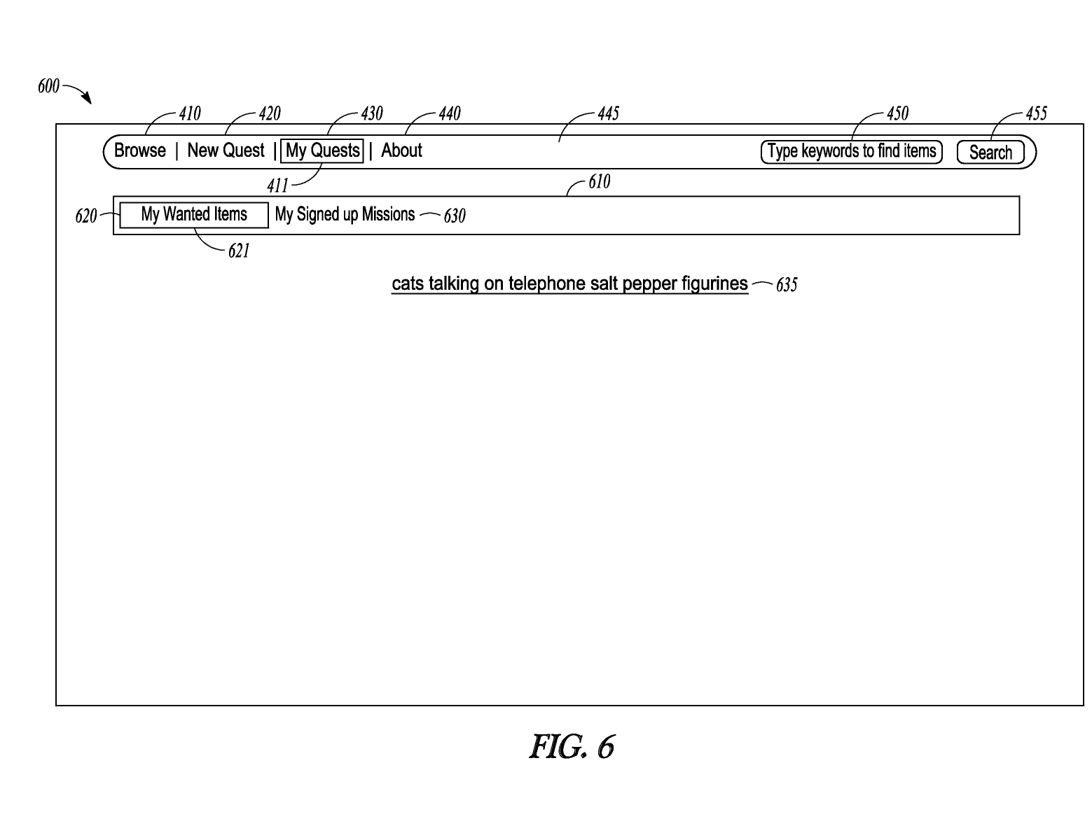

FIG. 6 is a screen shot illustrating a participant's view of a page 600 detailing the items wanted by the user. The page 600 includes a second toolbar 610 which includes links to “my wanted items” (requested items) 620 and “my signed up missions” (items to find) 630. The “my wanted items” 620 may either be highlighted or boxed by box 621 to indicate that is the page being viewed. Page 600 may list each item 635 requested as a link. The link then takes the user to see the detailed description of the requested item, and if any finders have signed up. This may be a similar layout to the browse function 400 layout.

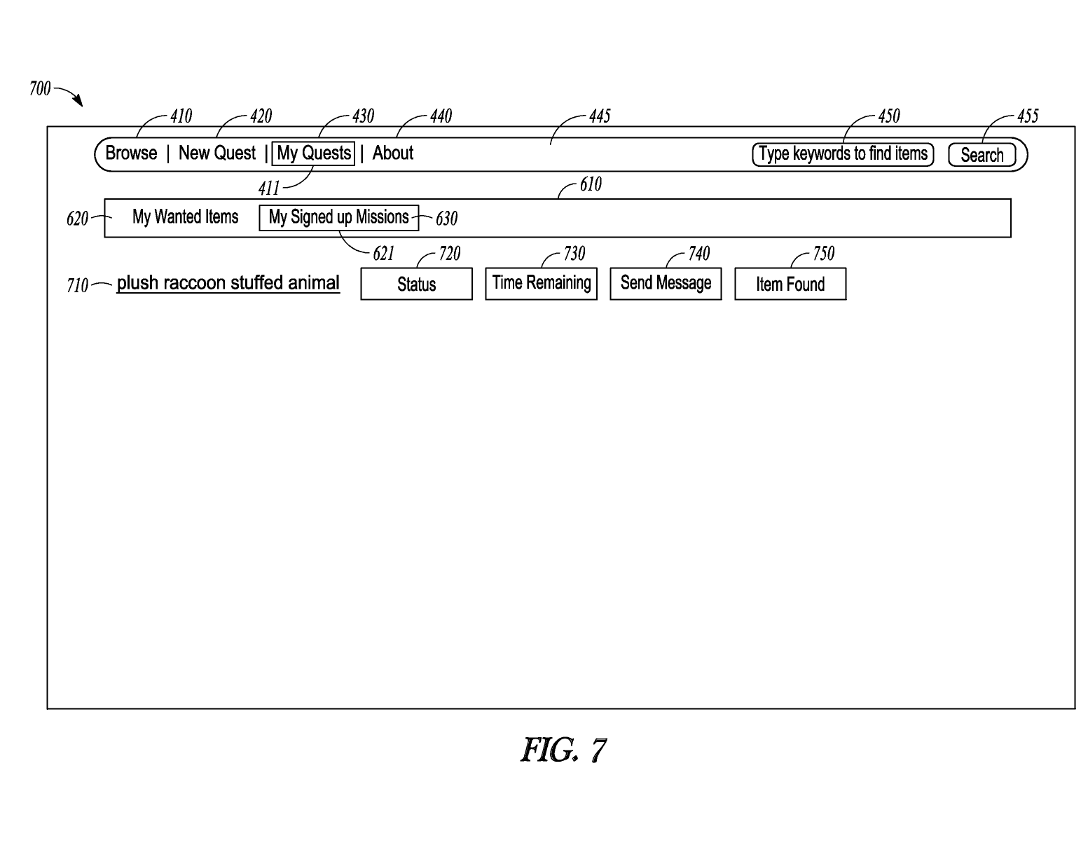

FIG. 7 is a screen shot illustrating another example of a participant's view of a page 700 showing “my signed up missions” (items signed up to find). Page 700 may be blank if the user has not signed up to find any items, and may include one or more items based on the number of items that the user has signed up to find. For example, if the user has signed up to find a plush raccoon stuffed animal then the plush raccoon stuffed animal is listed as link 710. The link 710 then takes the user to see the detailed description of the requested item, information about the requestor, and if any other finders have signed up. This may be a similar layout to the browse function 400 layout. Additionally, the status may be shown to the finder in status box 720. The status may be not found, time remaining, item found pending complete sale, item found over price, item found, time expired, etc. Box 730 provides the remaining time to find the item but may be blank when the time is unrestricted. The time may be shown in days, hours, weeks and/or other way to show remaining time. Message box 740 generates and sends a message and/or posts in a linked social media account such as Twitter® and/or Facebook®, and/or through an address book stored within the user's account information. Notification box 750 generates and sends a message to the requestor that the item is found.

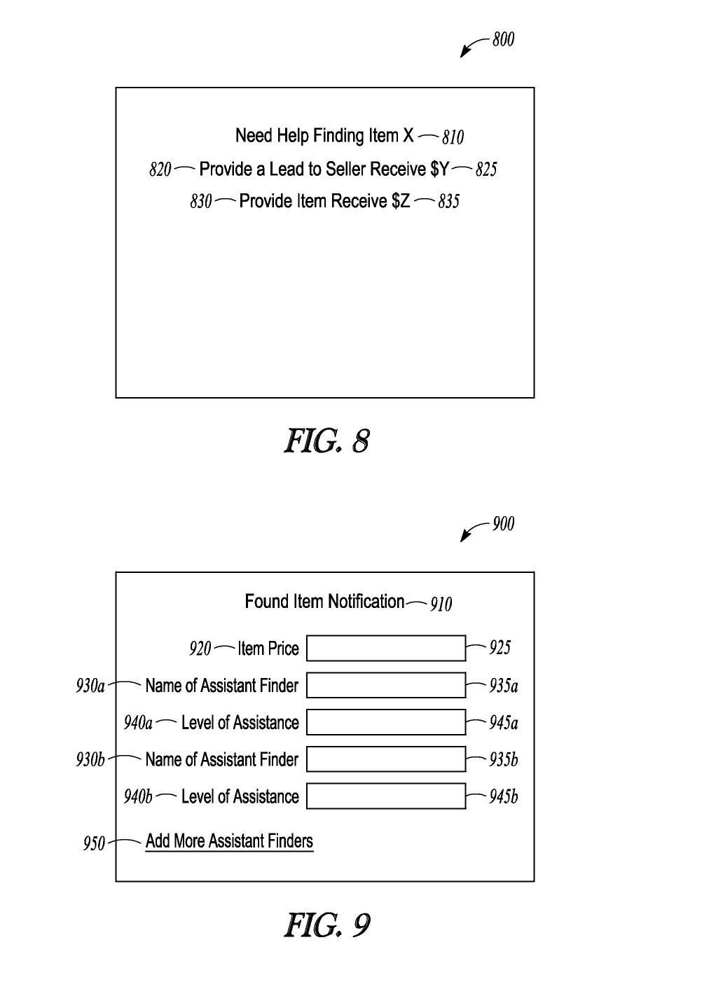

When a user selects message box 740, then communication message 800 as shown in FIG. 8 may be automatically posted to a linked social media account and/or a linked address book, or the communication message 800 may be edited prior to sending and/or posting. The communication message 800 may include a title 810 informing that the user needs help finding item X. For a finder fee system, the communication message 800 may include a dollar amount $Y 825 for providing a lead to a seller 820, and a dollar amount $Z 835 for providing the item 830. The dollar amounts 825, 835 may be set by the finder, automatically generated based on set percentages of the finder fee, or the percentages set by the finder. Alternatively, the message may include amount for the person who has the item and an amount for each level away from the person providing the item. Additionally, the message may change as more levels of a social network structure are added by other users sending a communication message.

When a user selects message box 740 (FIG. 7), then a notification message 900 as shown in FIG. 9 may be automatically generated. The notification message 900 includes a title 910 which show that it is a notification message. The finder then indicates the item price 920 in box 925. If the price 920 is above the requested amount 535 (FIG. 5), then the notification message may be converted to a negotiation message (not shown), where both parties need to agree on a price before the sale is complete. The name of the person may be their full name, an email, a social media account, and/or a username within the system 100. Then the finder indicates the name of assistant finder(s) 930a-930b by entering their name(s) in box(es) 935a-935b. The level of assistance 940a-940b is also provided n boxes 945a-945b. The level of assistance may be between 1 and n as listed in table 350 (FIG. 3B) when it is a finder fee system. Alternatively, it could list the social media levels away from the person who provided the item. If more than two people assisted, then link 950 allows the finder to add more names to the notification message 800.

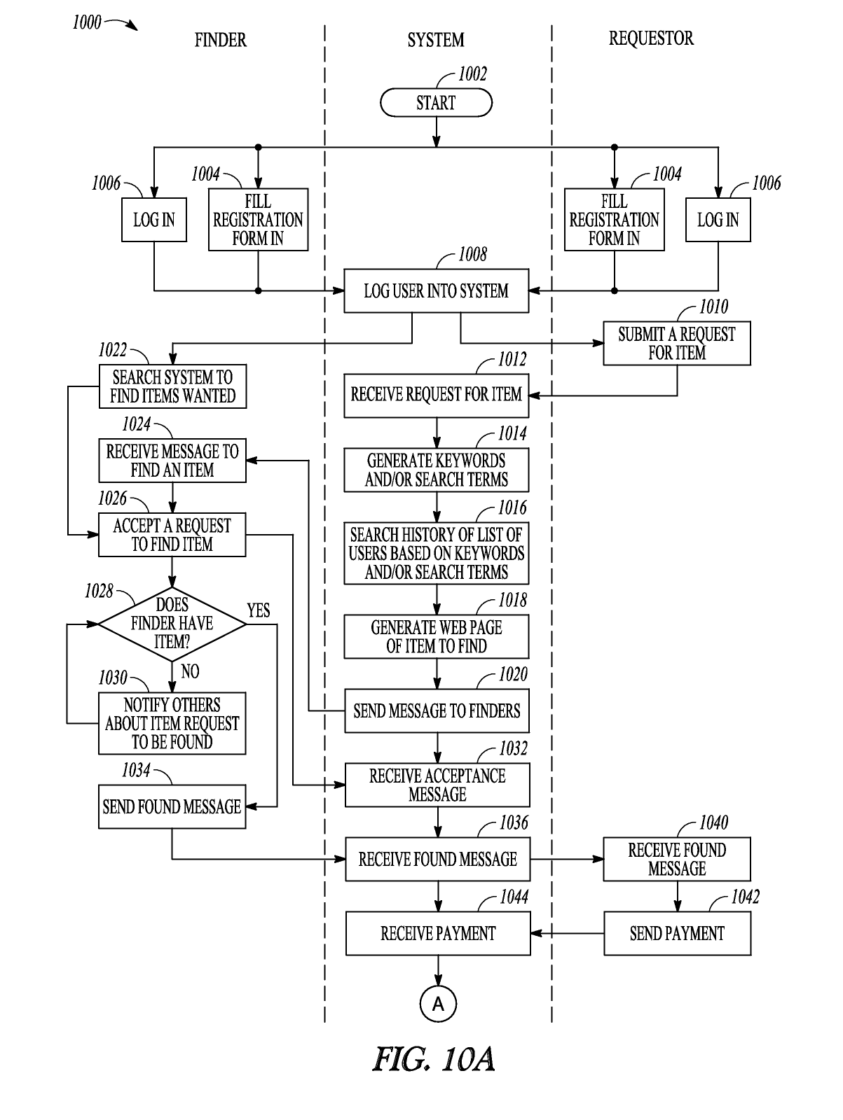

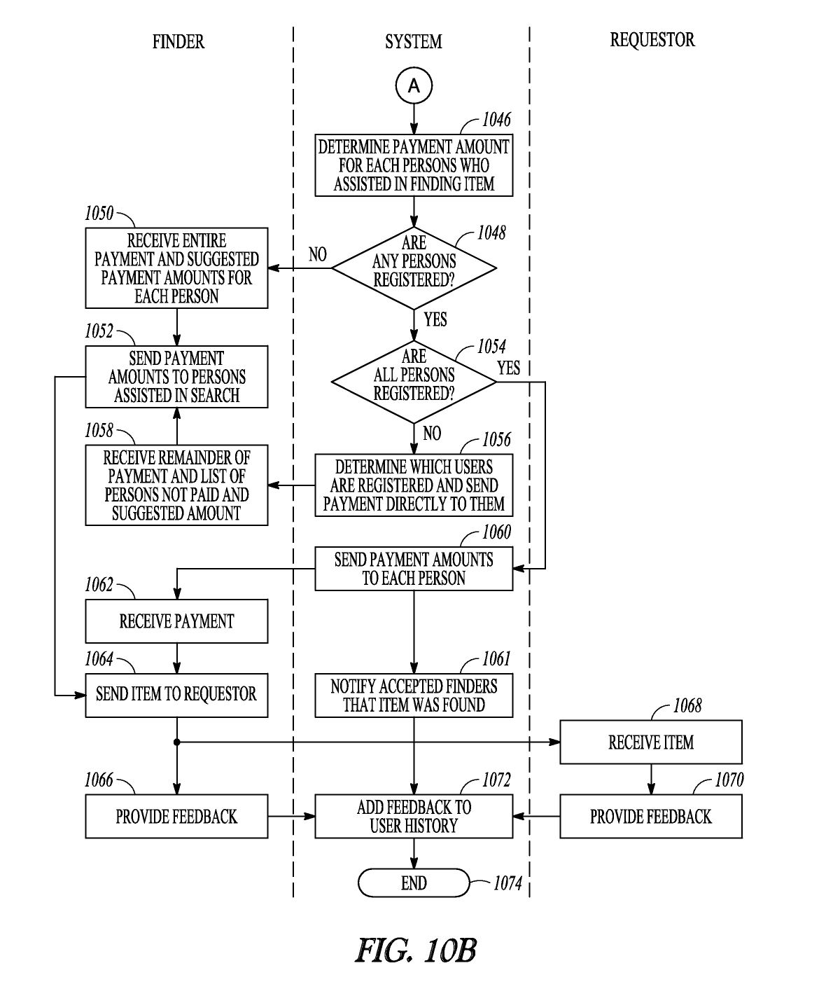

FIGS. 10A-10B is a representation of a process 1000 for assisting requestors (seekers) in locating items using finders (stallions). The process 1000 starts at step 1002, by either the requestor and/or finder filling in a registration form at step 1004 or logging in with a previously generated username and password at step 1006. The application server 122 then logs the user into the publication system 102 at step 1008. Next, at step 1010, the requestor (seeker) submits a request for an item by filing out request form 500 (FIG. 5) and submitting form 500. The publication system 102, then receives the request for item form 500 at step 1012. Next at step 1014, based on the description 525 in form 500, the publication system 102 generates keywords and/or search terms. Then at step 1016, the publication system 102 searches database(s) 128 (FIG. 1), which may include social media data culled from users' linked social media accounts, social connections, and/or transaction data from history table 320 (FIG. 3A) based on keywords and/or search terms to find one or more users that match the keywords and/or search terms. The keywords and/or search terms may also be used to place the item in a certain category and/or subcategory. Next at step 1018, the publication system 102 generates a webpage and/or an application page that is either searchable by keyword and/or locatable by a category.

The publication system 102 may send an informing message to one or more registered users at step 1020, if a match was found between one or more users and database(s) 128. The informing message includes a description of the requested item. The informing message may an email sent to the user's registered email account, a private message sent through a linked social media account, and/or a post on a linked social media account. The finder then receives the message to find the item at step 1024, and if the finder wants to find the item accepts the request to find the item at step 1026. Alternatively, the finder may search the published listings to find items that different people requested at step 1022, and from there the finder can accept a request to find an item at step 1026. The publication system 102 receives the acceptance message at step 1032 and incorporates the finders information in the users signed up to help, for example box 480 (FIG. 4).

The finder then determines if they have the item wanted at step 1028, and if yes, then they send a found message at step 1034. If they do not have the item, then the finder notifies other friends and/or users, at step 1030. The notification message may be sent directly to other friends through email and/or social media messaging such as chat or private mail. Also the notification mail may be posted within a social media account. The finder may draft the message or use a system generated message such as communication message 800. The message would inform each friend that each person who assisted in finding the item would be paid. One way may be a percentage of a finder's fee or based on the level away from the person supplying the item. If the finder is notified someone has the item or the finder can refer the requestor to the seller then the finder sends a notification message, such as message 900, at step 1034. The process 1000 may also end when a finder receives a message that the item was found by a different finder or other status updates.

At step 1036, the publication system 102 receives the found message, and the requestor receives a message that the item is found at step 1040. If the price is above the suggested value, the message may inform the requestor that the item was found, but at $N, and require that the requestor to agree to the price, counter the offer, or deny the sale. If the price is at or below the suggested price, then the requestor sends payment at step 1042 through a payment system within the publication system 102 or through a third party payment system. The publication system 102 then receives payment or confirmation from payment from third party site at step 1044.

At step 1046, the publication system 102 determines payment amount for each person who assisted in finding the item. The determination is based on a predetermined percentage of the finder's fee, user set percentages of the finder fee (set by user accepting request to find the item), or based on percentages set based on number of levels away from person providing item and total number of levels needed to locate the item. Next at step 1048, the publication system 102 determines if any persons that assisted in locating the item are registered with the system. If no, then the requestor may receive the entire payment amount or the entire finder fee and the suggested payment amounts for each person assisting at step 1050. Then the finder sends payment in the amounts suggested to the people who assisted in the search at step 1052. The publication system 102 then determines if all persons who assisted in locating the item are registered at step 1054, and if no, determines which users are registered and sends payment directly to the registers users who assisted in locating the item at step 1056. The finder then at step 1058 receives the remainder payment and a list of person or persons who have not been paid and their suggested amounts. Then the finder sends payment in the amounts suggested to the people who assisted in the search at step 1052. If all persons who assisted in locating the item are users, then, at step 1060, the publication system 102 sends payment to each user based on the amounts determined in step 1046. At step 1062, the finder receives their part of the payment based on the determination in step 1046. Payment may be made directly through the publication system 102 and/or through a third party system. Additionally, if a person assisting with locating the item is not registered with the system, by the finder entering an email address for the person assisting, they may receive payment directly from the publication system 102 and/or a third part' payment system.

If the finder has the item, then they send the item to the requestor at step 1064 or the person who has the item sends the item to the requestor. At step 1068, the requestor receives the item. At step 1061, the publication system notifies any other accepted finders that the item was found. Additionally, at other times during process 1000, the publication system may update the status of the item found, such as item located, item located pending payment, item located negotiating payment, etc.

At step 1066 and 1070, the finder and the requestor both provide feedback about the transaction, respectively. The publication system 102 then adds the feed back to each user's history at step 1072. At step 1074, the process 1000 ends.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer. The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-readable Medium

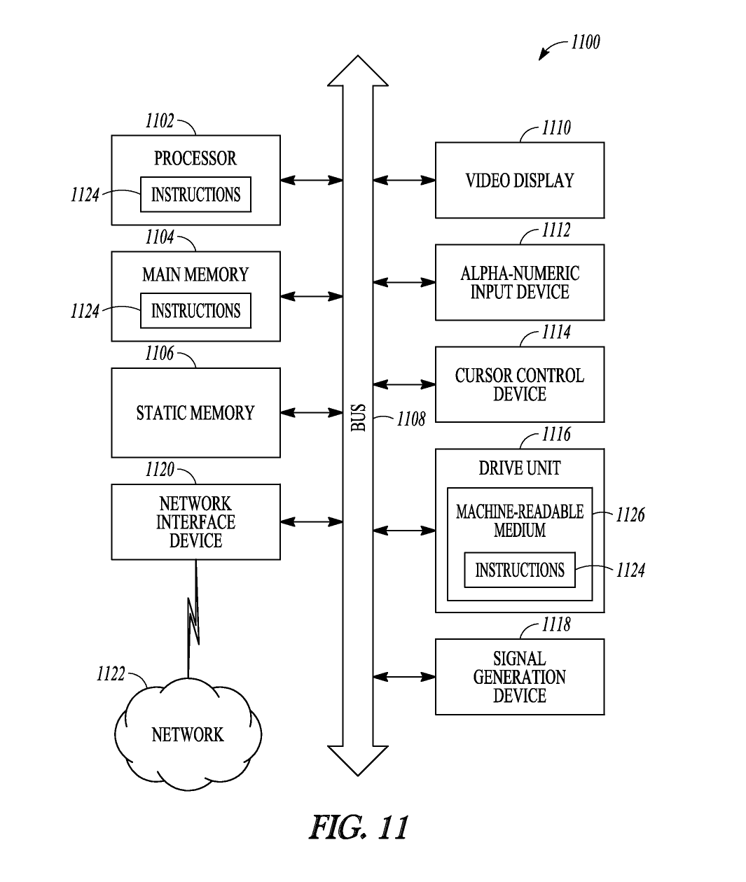

FIG. 11 shows a diagrammatic representation of machine in the exemplary form of a computer system 1100 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1100 includes a processor 1102 (e.g., a central processing unit (CPU) a graphics processing unit (GPU) or both), a main memory 1104 and a static memory 1106, which communicate with each other via a bus 1108. The computer system 1100 may further include a video display unit 1110 (e.g., a liquid crystal display (LCD) or a cathode ray tube (CRT)). The computer system 1100 also includes an alphanumeric input device 1112 (e.g., a keyboard), a cursor control device 1114 (e.g., a mouse), a disk drive unit 1116, a signal generation device 1118 (e.g., a speaker) and a network interface device 1120.

### Machine-Readable Medium

The disk drive unit 1116 includes a machine-readable medium 1126 on which is stored one or more sets of instructions (e.g., software 1124) embodying any one or more of the methodologies or functions described herein. The software 1124 may also reside, completely or at least partially, within the main memory 1104 and/or within the processor 1102 during execution thereof by the computer system 1100, the main memory 1104 and the processor 1102 also constituting machine-readable media. The software 1124 may further be transmitted or received over a network 1122 via the network interface device 1120.

While the machine-readable medium 1126 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure. The term “machine-readable medium” shall accordingly be taken to include, but not be limited to, solid-state memories, optical and magnetic media, and carrier wave signals.

### Transmission Medium

The instructions 1124 may further be transmitted or received over a communications network 1122 using a transmission medium. The instructions 1124 may be transmitted using the network interface device 1120 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method, comprising:
sending an acceptance, from a finder, that indicates that the finder has accepted a request to find an item requested by a requestor;
sending an electronic notification to one or more other people about the request for the item, wherein the electronic notification includes a monetary incentive for the one or more other people in addition to the finder to assist in locating the item;
sending location information, from the finder or one person of the one or more other people, wherein the location information includes a seller's contact information or a listing within an online marketplace describing the item; and
receiving compensation by the finder and the one person of the one or more other people based on assisting in locating the requested item.

2. The method according to claim 1, wherein the compensation is based on a type of assistance provided by the finder or the one or more other people in locating the item.

3. The method according to claim 1, wherein the one or more other people are compensated and a compensation amount for each person is based on a type of assistance provided in locating the item.

4. The method according to claim 1, wherein a percentage of total compensation for all persons assisting and locating the item is set and as more people are added the percentage of compensation of each person who assists in locating the requested item decreases.

5. The method according to claim 1, wherein the electronic notification is a message sent directly to the at least one other user.

6. The method according to claim 1, wherein the electronic notification is posted in at least one social media account announcing the request for the item.

7. The method according to claim 1, further comprising:
receiving a message with the request to find the item, wherein the message is sent based on previous listings, previous sales, or previous items found.

8. The method according to claim 1, further comprising:
facilitating a sale of the requested item to the requestor.

9. The method according to claim 1, further comprising:
sending a second acceptance, from a second finder, that indicates that the second finder has accepted a request to find the item requested by the requestor.

10. The method according to claim 9, wherein only one finder team receives compensation for finding the item, wherein the finder team includes at least the finder and one person of the one or more people that assisted in locating the requested item.

11. A method, comprising:
receiving a request to find an item;
generating, by one or more processors, one or more keywords based the request
determining one or more users from a search of a database using the one or more keywords;
sending an informing message to the one or more users, wherein the informing message includes a description of the item;
receiving an acceptance message from a finder;
receiving a found message from the finder, wherein the found message identifies at least one other person that assisted in locating the item;
receiving payment for the item from a requestor; and
generating a compensation amount for each of the finder and the at least one other person that assisted in locating the item.

12. The method of claim 11, wherein the compensation paid to the finder and the at least one other person is determined by a type of assistance provided in locating the item.

13. The method of claim 11, further comprising:
registering the finder to find items; and
storing in the database data related to previous sales, previous found items, previous bought items, or previous listings.

14. The method of claim 13, wherein registering further includes linking the finder to other accounts for selling items.

15. The method of claim 13, wherein registering further includes linking a social media account to the finder.

16. The method of claim 15, further comprising:
storing data in the database related to social connections from the social media account.

17. The method of claim 15, further comprising:
generating social media data using the one or more keywords to search the linked social media account; and
storing the social media data within the database.

18. The method of claim 15, further comprising:
in response to receiving the acceptance message, generating a message to post in the finder's linked social media account.

19. The method of claim 15, further comprising:
in response to receiving the acceptance message, generating a message to send to friends of the finder in the finder's linked social media account.

20. A non-transitory machine-readable storage medium comprising instructions that, when executed by one or more processors of a machine, cause the machine to perform operations comprising:
sending an acceptance, from a finder, that indicates that the finder has accepted a request to find an item requested by a requestor;
sending an electronic notification to one or more other people about the request for the item, wherein the electronic notification includes a monetary incentive for the one or more other people in addition to the finder to assist in locating the item;
sending location information, from the finder or one person of the one or more other people, wherein the location information includes a seller's contact information or a listing within an online marketplace describing the item; and
receiving compensation by the finder and the one person of the one or more other people based on assisting in locating the requested item.

21. A system, comprising:
a listing engine configured to receive a request to find an item;
a searching engine, executed by one or more processors, configured to determine one or more users from a search of a database using the one or more keywords; and
a referral engine configured (1) to send an informing message to the one or more users, and the informing message includes a description of the item, (2) to receive an acceptance message from a finder, (3) to receive a found message from the finder, and the found message identifies at least one other person that assisted in locating the item, and (4) to generate a compensation amount for each of the finder and the at least one other person that assisted in locating the item.
